(19) United States
(12) Patent Application Publication
(10) Pub. No.: US 2015/0350377 A1
(43) Pub. Date: Dec. 3, 2015

(54) PROVIDING ON-DEMAND SERVICES

(71) Applicant: Cisco Technology, Inc., San Jose, CA (US)

(72) Inventors: Ashok Iyer, Asheville, NC (US); Baseer Khan, Santa Clara, CA (US); Sreenivas Devalla, Union City, CA (US); Rajesh Kumar, Palo Alto, CA (US); Guarav Garg, Bangalore (IN)

(73) Assignee: Cisco Technology, Inc., San Jose, CA (US)

(21) Appl. No.: 14/290,698

(22) Filed: May 29, 2014

(51) Int. Cl. H04L 29/08; H04L 12/26

(52) U.S. Cl. CPC H04L 67/327; H04L 43/04

(57) ABSTRACT

A service system receives a request for a service from a computing device of a user. In response to receiving the service request, the service system determines the content of the request and communicates a data collection module to the user device. Based on the content of the request, the service system determines a data collection instruction. The service system communicates the data collection instruction to the data collection module, which executes the instruction, thus resulting in collection of data from the user device and/or devices associated with the user device. The service system then receives the collected data. Based on an analysis of the received data, for example, the service system determines a response to the service request. For example, the service system determines a service product that is responsive to the request. The service system then communicates the response to the user device.

### TECHNICAL FIELD

The present disclosure relates generally to providing remote client services, and more particularly to collecting data from a user computing network to provide remote client services.

### BACKGROUND

Conventional client service provisioning requires a vendor footprint at or within the client network. To collect the client data needed to provide a service, for example, the vendor must typically deploy a remote device—such as device hardware or a virtual (client-dedicated) appliance—within the client network. This architecture creates numerous challenges for the client and the vendor. For example, the client must approve both the deployed devices and any attendant data collector software associated with device. If the data collector is a hardware appliance, the hardware needs to be configured and shipped to the client. And, once the client receives the device, deployment of the device in the client network requires human support to make the data collector operational. For example, the client may need to configure firewalls and proxies to allow the data collector to communicate with external entities, such as the service hosting data centers. Further, clients that are not technically savvy oftentimes require significant vendor service support while configuring their networks to allow data collector operation.

All of these activities—approval, deployment, installation, and configuration—take considerable time. In some instances, completing these activities can even take several weeks. Unfortunately, such a delay can reduce market penetration for transactional business models where the client orders service on an as-needed basis. The delay is also bad for clients, especially those needing rapid turn around for their service-based requests.

### BRIEF DESCRIPTION OF THE DRAWINGS

FIG. 1 is a block diagram depicting a system for provisioning on demand client services, in accordance with certain example embodiments.

FIG. 2 is a block flow diagram depicting a method for on-demand client service provisioning, in accordance with certain example embodiments.

FIG. 3 is a block flow diagram depicting a method communicating data collection module to a user computing device, in accordance with certain example embodiments.

FIG. 4 is a block diagram depicting a computing machine and a module, in accordance with certain example embodiments.

### DETAILED DESCRIPTION OF EXAMPLE EMBODIMENTS

### Overview

In certain example embodiments, a method comprises a service computing system receiving a request for a service from a user computing device. In response to receiving the service request, the service computing system communicates a data collection module to the user computer device. The service computing system also determines the content of the service request, along with a data collection instruction based on the determined content of the service request. The service computing system then communicates the data collection instruction to the data collection module, which executes the instruction. In response to communicating the data collection instruction to the data collection module, the service computing system receives data associated with the content from the user computing device. For example, the service computing system receives the data from the data collection module. The service computing system then determines a response to the service request and communicates the response to the user computing system.

### DESCRIPTION

Example embodiments of the disclosed technology include computer-implemented methods, systems, and computer program products embodied in tangible media for providing on-demand provisioning of client services.

In certain example embodiments, the methods and systems described herein decrease the vendor footprint within a client network. That is, the methods and systems described herein dispense with the need for the deployment, installation, and configuration of a hardware device within a client network. Instead, data collection within the client network is accomplished via a data collection module that is dynamically downloaded and configured as part of the service transaction with the client. The complex data collection intelligence, for example, resides in a remote service system, which communicates with the data collection module via a telecommunications network.

More particularly, a user, such as a client or customer, requests an online service from a service provider (or service system). For example, the client requests a service via a service portal, which operates to front-end client transactions for the service system. As a result, when requesting services as described herein, the client does not have to perceive or appreciate any difference between the back-end components of the service system. Nor must the client perceive or appreciate the backend components of the service system when receiving the result of the requested service.

When submitting a service request, the client may provide client data, service data, and/or other end customer network data and information to the service system so that the service system can initiate and process the service request. Based on the client request, the service system provides a data collection module to the client. The client then installs the data collection module on the user device of the client. Hence, the client's user device becomes the host of the data collection module.

After installation of the data collection module on the user device of the client user, the service system uses the client-provided data and information to trigger data collection via the data collection module. For example, the service system uses the data and information to determine a data collection instruction, which the service system transmits to the data collection module on the user device via the network. The data collection module then executes the instruction, thereby collecting the relevant data from the client-side network. The data collection module then transmits the collected data to the service system.

After receiving the collected data, the service system can process the data to provide a response to the client's service request. That is, the service system determines a service product for the client based on all or part of the collected data. The service system can then notify the client, such as via the service portal and/or email, upon completion of data collection and processing for the service request. The client may access service products, such as service product results, reports, documents, spreadsheets, and/or software patches, via the service portal. Hence, with the methods and systems provided herein, a client can, among other things, request and receive on-demand services from a service provider.

Example System Architectures

Turning now to the drawings, in which like numerals indicate like (but not necessarily identical) elements throughout the figures, example embodiments are described in detail.

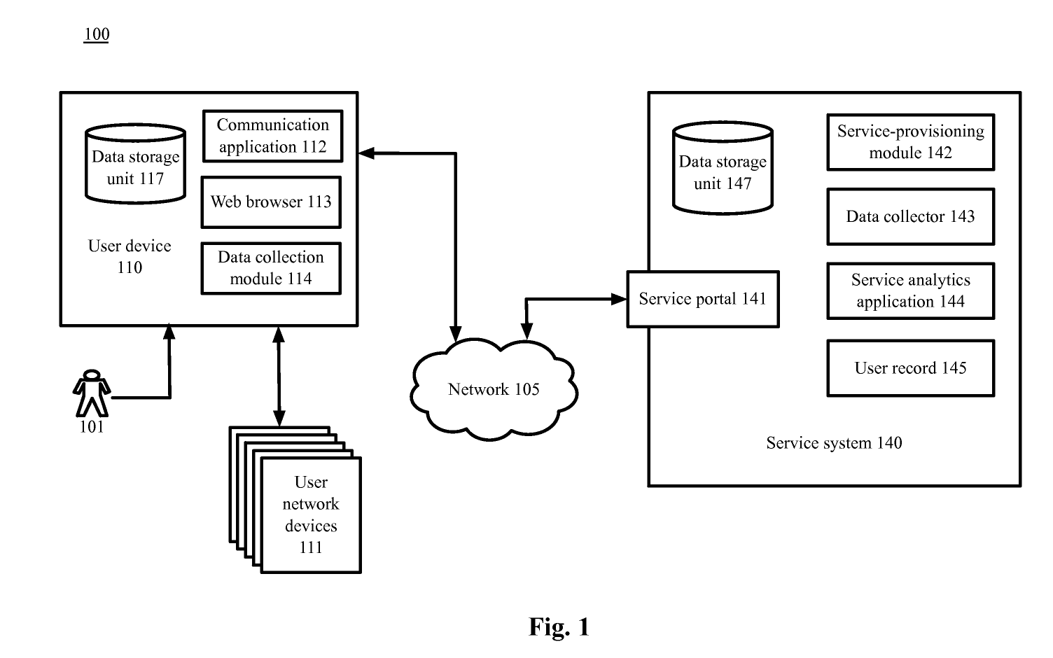

FIG. 1 is a block diagram depicting a system for a system for provisioning on demand client services, in accordance with certain example embodiments.

As depicted in FIG. 1, the exemplary operating environment 100 includes a client-side, user network computing device 110 and a service-side, service computing system 140 that communicate with each other via one or more networks 105. Each network 105 includes a wired or wireless telecommunication means by which network computing devices (including devices 110 and 140) can exchange data. For example, each network 105 can include a local area network (“LAN”), a wide area network (“WAN”), an intranet, an Internet, a storage area network (SAN), a personal area network (PAN), a metropolitan area network (MAN), a wireless local area network (WLAN), a virtual private network (VPN), a cellular or other mobile communication network, Bluetooth, near field communication (NFC), optical networks, or any combination thereof or any other appropriate architecture or system that facilitates the communication of signals, data, and/or messages or objects. Throughout the discussion of example embodiments, it should be understood that the terms “data” and “information” are used interchangeably herein to refer to text, images, audio, video, or any other form of information that can exist in a computer-based environment.

Each network computing device 110 and 140 includes a communication module capable of transmitting and receiving data over the network 105. For example, each network device 110 and 140 can include additional system components, such as a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110 and 140 are operated by client system operators or service system operators, respectively.

The user 101, such as a client user 101, can employ a communication application 112, such as a web browser application 113 or a stand-alone application, to view, download, upload, or otherwise access documents or web pages via a distributed network 105. The communication application 112 of the user computing device 110 can interact with web servers or other computing devices connected to the network 105. For example, the communication application 112 can interact with the user network computing device 110, associated user network devices 111, and the service system 140. For example, the user device 110 can interact with the service portal 141 of the service system 140 via the network 105. The web browser 113 of the user device 110 provides a user interface, for example, for accessing other devices associated with the network 105.

The data collection module 114 represents a plugin, applet, or other application that operates to collect data from the user device 110 and/or associated user network devices 111 of the client-side network. For example, the user device 110 receives a download for the data collection module 114 from the service system 140, and installs the data collection module 114 on the user device 110. The user device 110 then operates as the host for the data collection module 114. That is, the data collection module 114 operates as a client-side link with the service system 140 to perform on-demand data collection for the service system 140 as described herein. The data collection module 114, for example, is configured to perform low-level device reads, such as Command Line Interface (CLI) over telnet, Simple Network Management Protocol (SNMP), and/or Hypertext Transfer Protocol (HTTP). As described herein, the service system 140 can provide collection intelligence and instructions—as well as scheduling and coordination commands—to the data collection module 114 for execution within the client-side network.

The user computing device 110 may also include a data storage unit 117. The example data storage unit 117 can include one or more tangible computer-readable storage devices. The data storage unit 117 can be a component of the user device 110 or be logically coupled to the user device 110. For example, the data storage unit 117 can include on-board flash memory and/or one or more removable memory cards or removable flash memory. In certain example embodiments, the data storage device 117 may include data needed to process a service request. Hence, the data collection module 114 may be configured, for example, to access the data storage unit 117.

The service computing system 140 represents a system for receiving and processing a user 101 request for services, as well as providing services to the user 101. The service computing system 140 also operates, for example, to provide the data collection module 114 to a user device 110 for downloading and installation, to configure the data collection module 114 for data collection. The service computing system 140 includes a service portal 141, which provides an access point to the service computing system 140. For example, the service portal 141 may host a website that the user 101 can access when requesting a service from the service system 140.

In certain example embodiments, the service computing system 140 may also include a service-provisioning module 142, a data collector 143, and a service analytics application 144. The service-provisioning module 142 represents the computer-implemented system to receive and coordinate a service procurement transaction with the user 101. That is, the service-provisioning module 142 may receive user 101 requests for service and thereafter establish a user record 145 for new or existing users 101 as described herein.

The data collector 143 represents the computer-implemented system, for example, to determine data collection parameters for data collection on a user device 110 and/or associated user network device 111. For example, the data collector 143 may determine and configure an instruction to the data collection module 114 regarding the data to be collected. The data collector 143 may also receive collected data from the data collection module 114, and then communicate the received data to the service analytics application 144.

The service analytics application 144, for example, represents the computer-implemented system that processes data that the service system 140 receives from the user device 110 and/or any associated user network devices 111 on the client-side network. Hence, the service analytics application 144, for example, may be responsible for analyzing received data and generating a service product for the user 101 based on the received (and analyzed) data.

As disclosed herein, the service-provisioning module 142, data collector 143, and service analytics application 144 can interact and communicate with each other, for example, so as to receive, process, and provide a service product to the user 101 as described herein. The service-provisioning module 142, data collector 143, and service analytics application 144 may also interact with the user device 110, such as via the service portal 141. For example, the data collector 143 may interact with the user device 110, such as via the service portal 141, the network 105, and the data collection module 114, to provide instructions to the data collection module 114.

The service system 140 may also include an accessible data storage unit 147. For example, the data storage unit 147 may store data received from the data collector 143. The example data storage unit 147 can include one or more tangible computer-readable media. The data storage unit 147 can be stored on the user device 110 or can be logically coupled to the service system 140. For example, the data storage unit 147 can include on-board flash memory and/or one or more removable memory cards or removable flash memory.

Remote, network-based hosting of the data collection and data processing functions as described herein implies geographical transparency of the system architecture. In other words, the data collection module 114 may communicate and associate with the nearest service system 140 for data collection. Service related functions and components—such as collection processing, service provisioning, commerce, and analytical applications—are associated with the service system 140 and may be geographically separated. That is, the service-provisioning module, the data collector 143, and the service analytics application 144 may exist in the same data center location or may be distributed among two or more geographically separate data center locations.

In certain example embodiments, the service system 140 components and associated functionality may be distributed across an enterprise service bus that includes several data centers. Additionally or alternatively, the methods and systems described herein are applicable when the service system 140 operates as both the service vendor and the service hosting entity, as well as when the service system 140 includes services hosted by an entity that is different and distinct from the service vendor.

It will be appreciated that the network connections shown are example and other means of establishing a communications link between the computers and devices can be used. Additionally, those having ordinary skill in the art and having the benefit of the present disclosure will appreciate that client-side user device 110 (and associated user network devices 11) and the service computing system 140 of FIG. 1 can have any of several other suitable computer system configurations. For example, the user device 110 and example components thereof may be embodied as a mobile phone or handheld computer and may not include all the components described above.

Example Processes

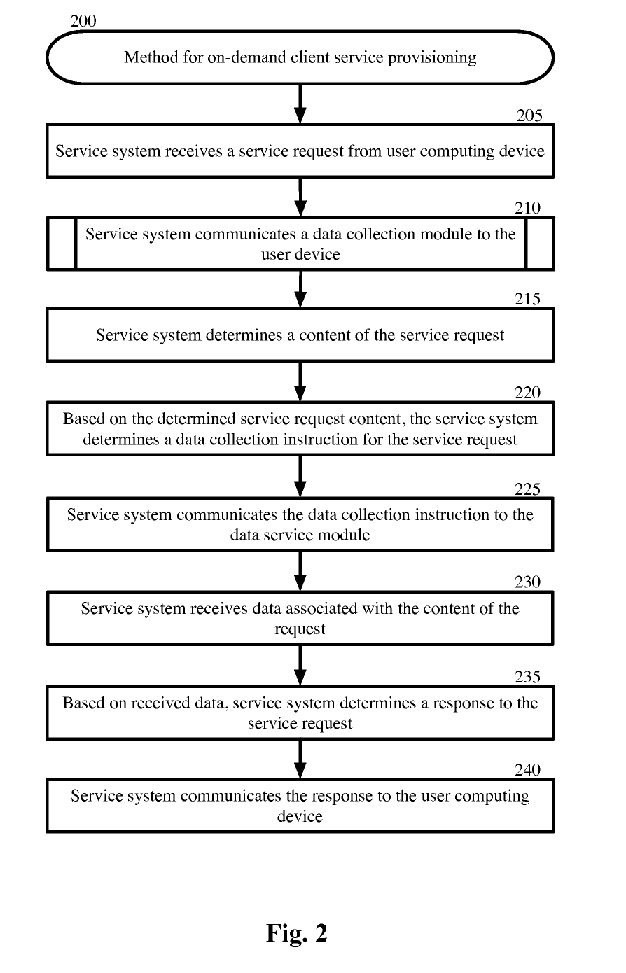

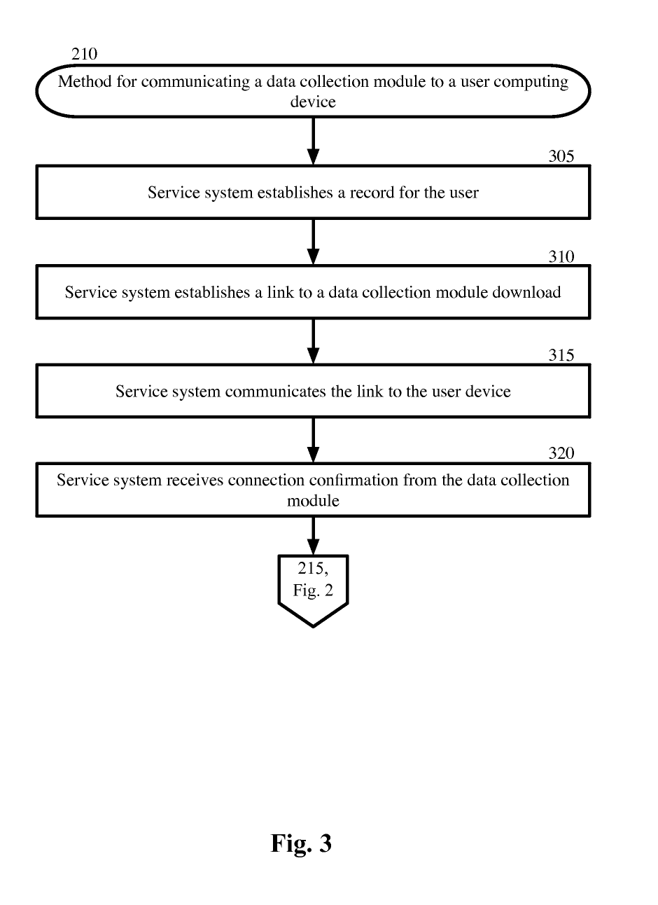

The components of the example operating environment 100 are described in further detail hereinafter with reference to the example methods illustrated in FIGS. 2-3.

In accordance with certain example embodiments, a service portal 141 provides a user 101, such as a client user 101, access to the service system 140. For example, a user 101 that does not have service contract with the service system 140 may use a publically available website (not shown) associated with the service portal 141 of the servicer system 140 to initiate the process of procuring services from the service system 140. A service-provisioning module 142, for example, may then initiate and coordinate the service procurement transaction for the user 101. When accessing the website, for example, the user 101 may not know (or care) where the service portal 141 and service-provisioning module 142 are hosted. The user 101 may likewise be unaware of other backend components of the service system, such as the data collector 143 and/or any service analytics applications 144.

When providing the service request, the user 101 can provide information to the service system 140 that allows the service system 140 to create a user record (or account) for the particular user 101. For example, the user 101 may provide a user name and password that permit the user 101 secure access to the service system 140. The user 101 can also ultimately procure a service, such as by selecting or providing relevant service parameters and target network data as part of the task flow as described herein. Alternatively, a user 101 that has previously registered with the service system can input existing login credentials to access the service system 140, such as via a user interface of the service portal 141, to request and receive a service product from the service system 140.

In certain example embodiments, the service system 140, such as via the data collector 143, relies on the user-supplied information to determine configuration parameters for the data collection module 114. That is, the data collector 143 of the service system 140 may rely on the user-supplied information to determine establish certain data collection parameters associated with the data collection module 114. Alternatively, the service system 140 may rely on a generic data collection module 114. That is, the data collection module 114 may be used across a variety of different users. In certain example embodiments, the service system 140, such as via the service-provisioning module 142 and/or the data collector 143, may also configure entitlement checks that the service system 140 applies to service portal 141 access.

Upon completion of the service procurement transaction, the service system 140 provides a link, such a Uniform Resource Locator (URL), which permits the user 101 to download and install the data collection module 114 on the user device 110. With the user's permission, for example, the data collection module 114 can execute on the user device 110. For example, the data collection module 114 may execute a received data collection instruction as described herein. As part of the execution, the data collection module 114 securely connects to the service system 140, such as via the service portal 141. For example, the data collection module 114 may connect to the data collector 143 via the service portal 141 of the service system. Once connected to the data collector 143, the data collection module 114 can receive the data collection instruction for the data collection parameters. In other words, the data collection module 114 can, in certain example embodiments, self-configure the data collection parameters on the user device 110 based on configuration instructions received from the data collector 143 of the service system 140.

Following the configuration of the data collection module 114, the data collection module 114 completes the data collection from the user device 110 and/or the associated client-side network devices 111 associated with the user device 110. The data collection module 114 then uploads the collected data to the data collector 143. For example, the data collection module 114 may rely on an outbound file transfer protocol, such as Hypertext Transfer Protocol Secure (HTTPS), to communicate collected data. In certain example embodiments, the data collection module 114 may batch process the data upload, such as in size-managed batches.

Based on the services to be procured, the data collector 143, for example, forwards the collected data to one or more backend service analytics applications 144. The service applications 144 then apply a combination of profiling, enriching, analytics and other modes of processing to the data to ultimately generate a service product. In certain example embodiments, the user 101 may be notified, such as via an email and/or via the service portal 141 when the processed data is available as a viewable service product. The user 101 can then access the service product. The user 101, for example, may not see or appreciate a difference between service-provisioning module 142, the data collector 143, and/or the one or more service analytics applications 144 during the procurement and processing.

The services to which the methods and systems described herein are applicable can be any vendor-side/client-side service that would otherwise require the deployment of a device (or virtual device) within the client-side network. Such services include, for example, transactional services, subscription-based services, and self-service services. For example, the service may be a transaction-based discovery service in which the service system 140, via the data collection module 114, collects device inventory, contract, and lifecycle information from devices in pre-sales scenarios. The service product resulting from such a service my include, for example, a report offering suggestions to improve the user's network to meet a variety of objectives such as the introduction of a new service or capability. The report may also identify user products that are near end-of-life so that the user can plan for a product replacement to avoid any service disruptions. Additionally or alternatively, the service may relate to collecting a user inventory and topology map of a user's network, and then identifying nodes with out-of-date software. The service product may be a report that identifies the out-of-date software. Additionally or alternatively, the service may relate to debugging data for a Technical Assistance Center (TAC). For example, the Technical Assistance Center may need to collect data from user network elements as the Technical Assistance Center is processing a technical service request. With self-service services, for example, the service system 140 can deliver services in which the user 101 plays a central role in defining what they need. For example, the user interacts with the service portal 141 to get the service the user 101 needs without the involvement of any service system 140 personnel.

For transactional-based services, the service system 140 may process financial services associated with the transaction, such as during the service procurement transaction. In certain example embodiments, a “coupon code” may be issued to the user 101. The user 101 can then enter the “coupon code” when providing payment of the service. For subscription (contract-based) services, each service request may be handled as a transaction for which there is no payment associated with any service request, so long as the subscription payments are current. For example, once the subscription service has been activated, such as via the service-provisioning module 142, any entitlement checks will return affirmative results for the duration of the service contract. Further, items such as the installed data collection module 114 and customer network data can be retained between service requests with minimal resource consumption, to be updated at the next service request as needed. The user 101, for example, may be provided with a user-friendly user interface setting for deleting such items after a service request, with retention as the default.

In certain example embodiments, the methods and systems described herein may be employed to facilitate the provisioning of technical assistance to a user 101. For example, a user 101 calls, instant messages, or emails a Technical Assistance Center (TAC) for help. Additionally or alternatively, an automatic notification of an exception condition (such as a Smart Call Home notification or “SCH”) is forwarded from the affected user device 110 (or associated user network devices 111) to the Technical Assistance Center. The Technical Assistance Center, which functions as the service system 140 in this example, then receives the notification. A Technical Assistance Center operator or engineer may then use their expertise to analyze the customer's request and/or the SCH notification to formulate a set of collection instructions to match the technical issue that is the subject of the notification and/or SCH. Additionally or alternatively, the instructions may be programmatically derived, for example, using an application or tool that analyzes the SCH notification and/or data pertaining to the customer request that is manually entered by the Technical Assistance Center. The Technical Assistance Center, operating as the service system 140, may then provide the instructions to the service-provisioning module 140 for later customer-side download as described herein.

In certain example embodiments, the Technical Assistance Center may issue a time-bound, user-specific “coupon code” which the user 101 employs to procure service from the service system 140. After providing any needed user information to procure the service, the Technical Assistance Center communicates the data collection module 114 to the user device 110 for installation. For example, the Technical Assistance Center provides an email to the user 101 with a link for downloading the data collection module 114.

After installation of the data collection module 114, the data collection module 114 receives instructions from the Technical Assistance Center for data collection. Execution of the instructions results in data collection on the user device 110 and/or associated network devices 111. The data collection module 114 then communicates the collected data to the Technical Assistance Center, which relies on the collected data for troubleshooting the user's problems and processing the user's help request. The collected data can include, for example, installed base data, syslogs, Simple Network Management Protocol (SNMP), or other types of data. Data processing can include data enrichment, root cause analysis, counterfeit assessment, or other types of data processing known to those skilled in the art. The Technical Assistance Center reads the processed results and provides the relevant results to the user 101. In certain example embodiments, the Technical Assistance Center iterates this example process with a different data collection focus.

In certain example embodiments, such as in the above Technical Assistance Center example, a “clientless” Secure Sockets Layer Virtual Private Network (SSL VPN) or a WebSocket Virtual Private Network may be used to provide bidirectional connectivity between the data collection module 114 and a Technical Assistance Center workstation. The Technical Assistance Center may, for example, override such a bidirectional tunnel to a browser plugin that supports a Jump Server function (also known as a Remote Device Access or “RDA”), and log into end devices for tasks such as troubleshooting via telnet, Secure Shell (SSH), Hypertext Transfer Protocol Secure (HTTPS), or other protocol. Even so, in certain example embodiments, such bidirectional connectivity is needed. That is, the methods and systems described herein may rely on bidirectional or unidirectional connectivity between the user 101 and the service system 140.

The methods and system described herein are applicable, for example, to networks of different sizes, such as small, medium, and large networks. In certain example embodiments, the network size may include thousands of devices, such as about 10,000 devices or less. For example, the user device 110 can be a laptop or tablet, which can assist data collection for small to medium sized networks with up to a few thousand devices. Data collection for larger client-side networks may require larger, more robust user devices 110 as the host device.

In accordance with the methods and systems described herein, the user device 110 that hosts the data collection module 114 is part of the client network, and hence may be connected to multiple network devices 111 in the client-side network. If there are internal firewalls within the client network, then the user device 110 host may be part of a client-side, Virtual Local Area Network (VLAN) or equivalent so that the user device 110 has access to the network devices 111. In smaller networks with no internal firewalls, a greater flexibility may exist in the placement of the data collection module 114 on a user device 110 host, including external Virtual Private Network (VPN) access such as from a user device 110 located at a client user's home office. Virtual Private Network (VPN) access from the user device 110 host into the client's network is distinct from client-site-to-backend connectivity and is a natural consequence of remote working.

With large networks, batched, cloud-based collection with the data collection module 114 handling groups may be employed. In certain example embodiments, such as with large networks, multiple, strategically-selected user devices 110 can be used—in conjunction with the data collection module 114—to collect data as described herein. For example, in large networks, multiple data collection modules 114 may be communicated to one or more user devices 110 of the client network so as to collect data across the network as described herein. The multiple data collection modules 114 may then, in the aggregate, for example, communicate collected data to the service system 140. The service system 140 then processes the data to product a service product. For example, the service system 140 may communicate 5, 10, 15, 20, or more data collection modules 114 to a client-side system that includes multiple devices. The service system 140 may then communicate one or more data collection instructions to the one or more data collection modules. Upon execution of the instructions, the data collection modules 114 collect the data and communicate the data to the service system 140, which then process the data and provides a service product as described herein.

By dispensing with the need for remote device deployment and installation, for example, the methods and systems described herein reduce that delays associated with conventional client service provisioning. The methods and systems described herein also provide efficient and streamlined connectivity between the client network and the service system 140. For example, there is no need for unsolicited connection requests from the service system 140 data center to the client location. And because the data collector 143 is hosted at the service system 140—with data collection achieved via the data collection module 114 on the user device 110—there is no need for “always on” Virtual Private Network (VPN) connectivity.

FIG. 2 is a block flow diagram depicting a method 200 for on-demand client service provisioning, in accordance with certain example embodiments.

With reference to FIGS. 1 and 2, in block 205, the service system 140 receives a service request from user computing device 110. That is, a user 101, for example, transmits a request to the service system 140 for a service via the network 105. For example, the user 101 may employ the web browser 113 to access a website (not shown) of the service system 140, where the user 101 can provide a service request. Additionally or alternatively, the user 101 may email a service request to the service system 140. If a user 101 already has a record 145 (or account) with the service system 140, the user 101 may provide the request via the existing user record 145, such as by logging in to the user record 145 and making the request.

The service request may include, for example, a description or indication of the specific type of service that the user 101 desires. For example, the request may indicate that the user 101 needs technical assistance as described herein. The service request may also include information and data regarding the user device 110 and/or associated user network devices 111. For example, the service request may identify specific network user devices 111 associated with the user device 110 that may contain data relevant to the service request. The service request may also indicate the types of data that the data collector 143 may collect. The service request may also include identifying information for the user 101, such as the name, address, organization name, payment information and/or any other information regarding the user 101.

In block 210, the service system 140 communicates a data collection module 114 to the user device 110 in response to receiving the service request. That is, after receiving the user's request for service, the service system 140 establishes a record (or account) for the particular user 101, such as when the user 101 does not already have a record 145 with the service system. The service system 140 then provides the user 101 with a link, for example, to download and install the data collection module 114. After installation of the data collection module 114 on the user device 110, the service system 140 may confirm the service system 140 connection to the data collection module 114 of the user device 110. The example details of block 210 are described in further detail below with reference to FIG. 3.

FIG. 3 is a block flow diagram depicting a method 210 for communicating a data collection module to a user computing device 110, as referenced in block 210 of FIG. 2.

With reference to FIGS. 1 and 2, in block 305 of method 210, the service system 140—after receive a service request from a user 101—establishes a record 145 for the user 101 as part of the service transaction procurement. That is, the service system 140 associates the information and data received from the user 101 with a record 145 (or account) for the particular user 101. In certain example embodiments, such as when the user 101 has not previously requested and/or received a service from the service system 140, the service system 140 may register a new user 101 record 145 with the service system 140. For example, the service system 140, such as via the service-provisioning module 142, may associate the new user's name, address, organization name, payment information and/or any other information with the user record 145. The service system 140 may also determine a username and password for the user 101, which the service system 140 associates with the user record 145 for the particular user 101.

After establishing a user record 145, the user 101 can then employ the username and password to securely access the user record 145 as described herein. For example, after the service analytics application 144 provides a service product as described herein, the service system 140 may associate the service product with the user record 145 so that the user 101 can securely access the service product.

In block 310, the service system 140, such as via the service-provisioning module 142, establishes a link to a data collection module 114 download. For example, the service system 140 associates the data collection module 114 with a Uniform Resource Locator (URL) so that accessing the Uniform Resource Locator (URL) directs the user 101 to download instructions for the data collection module 114. In certain example embodiments, the service system 140, such as via the service-provisioning module 142, may associate the data collection module 114 link with a user control option, such as a “download now” or “install data collector module” button. By clicking or otherwise selecting the button, a user 101 can initiate the process of downloading and installing the data collection module 114.

In block 315, the service system 140 communicates the link (or URL) to the user device 110. That is, the service system 140 transmits the link for the data collection module 114 download to the user device 110 via the service portal 141 and the network 105. For example, if the service system 140 has associated the data collection module 114 download link with a user control option, the service system 140 emails, texts, or otherwise communicates the user control option to the user device 110. The service system 140 may also provide access credentials to the user 101, such as the determined login username and password, so that the user 101 can access the user record 145. That is, in the same or separate communication as the link to the data collection module 114 download, the service system 140 may provide login (access) credentials to the user 101 so that the user 101 can access the record 145. The user then receives the link to the data collection module 114 download, along with any access credentials for the user record 145.

Additionally or alternatively, the service system 140 may communicate the link to the data collection module 114 download to the user 101 via a user interface associated with the service system 140. For example, if a user 101 is an existing user 101, the user 101 may employ the user's existing username and password to access the user record 145 for the user 101. After accessing the account, for example, the service system 140 may present the link to the data collection module 114 download on a secure website of the service system 140. For example, the service system 140 may provide the user control option, such as the “download now” button described herein, on the website of the service system. The user 101 can then view and access the user selection option via the web browser 113 of the user device 110.

After receiving the link to download the data collection module 114, the user 101 can access the link, such as by clicking or otherwise selecting the link. For example, the user 101 may click on or otherwise access the “download now” user control option associated with the data collection module 114 download link. By accessing the link, the user 101 initiates installation of the data collection module 114 on the user device 110. For example, clicking on the link may result in downloading of the data collection module 114 on the user device, whereupon the data collection module 114 may guide the user 101 through installation of the data collection module 114. Alternatively, accessing the link may results in both downloading and installation of the data collection module 114 on the user device 110. Once the data collection module 114 is installed, the data collection module 114 can receive communications from the service system 140, such as data collection instructions, as described herein.

In block 320, in certain example embodiments, the service system 140 receives connection confirmation from the data collection module 114. That is, after the user 101 installs the data collection module 114 as described herein, the service system 140 detects the access and checks that the installation is complete and that a connection between the data collection module 114 and the service portal 141 of the service system 140 has been established. For example, the data collection module may be configured to communicate a message to the service system 140, such as to the data collector 143 and/or the service-provisioning module 142, indicating that installation on the user device 110 is complete. Additionally or alternatively, the data collector 143, for example, may communicate connection checks and verifications to the data collection module 114 to confirm successful installation of the data collection module.

In certain example embodiments, once the connection between the data collection module 114 and the service portal 141 has been confirmed, the service system 140 may receive additional information from the user device 110 of the user 101 regarding the service request. For example, the data collector 143 may request and/or receive additional information regarding data collection parameters regarding the service request. If the service request relates to a technical assistance need, the data collector 143 may request information regarding the specific of the technical assistance need, such as what network devices the need pertains to, for example.

Returning to FIG. 2, in block 215 of FIG. 2, the service system 140 determines a content of the service request. That is, based on the information received from the user device 110 of the user 101 regarding the service request, the service system 140 reads the service request information to determine the requests content. For example, if the request relates to a technical assistance inquiry, the services system 140—such as via the data collector 143—determines that the request relates to technical assistance request. If the request includes information regarding data collection parameters associated with the technical assistance request—such as on what devices relevant data may be present—the data collector 143 determines that the content includes specific, data-collection information relating to the service request.

In block 220, based on the determined service request content, the service system 140 determines a data collection instruction for the service request. That is, the data collector 114, based on the content of the service request, configures a computer program command or set of commands that—when executed by the data collection module 114 on the user device 110—causes the data collection module 114 to collect the data needed to respond the service request as described herein. For example, the instruction (or instruction set) may be configured to inform the data collection module 114 of what data to collect, where the data may be located within the client-side network, and/or how to organize the data once collected. If the request content relates to a technical assistance request, for example, the instruction may, when executed, cause the data collection module 114 to determine, collect, and/or organize data—within the client-side network—that is responsive to the technical assistance request content.

In block 225, the service system 140 communicates the data collection instruction to the data service module 114. That is, after determining and configuring the data collection instruction, the service system 140 transmits the data collection instruction, via the network 105, to the data collection module 114 on the user device 110. For example, the service system 140 may communicate the data collection instruction to the data collection module 114 via the service portal 141. In certain example embodiments, the service system 140 may communicate the data collection instruction to the data collection module 114 via a email, text, and/or other communication. In certain example embodiments, the user 101 may log in to the user record 145 via the service portal 141, and the service system may communicate the instruction to the data collection module 114 via verified, secure connection. The data collection module 114 then receives the data collection instruction.

In block 230, the service system 140 receives data associated with the content of the request. That is, in response to receiving the data collection instruction from the service system 140, the data collection module 114 on the user device executes the instruction, thus triggering the collection of data associated with the user device 110 and/or any associated user network devices 111. For example, if the service request content relates to a technical assistance request, the execution of the data collection instruction causes the data collection module 114 of the user device 110 to determine, collect, and/or organize data—within the client-side network—that is responsive to the technical assistance request content. The data collection module then communicates the collected data to the service system 140, such as to the data collector 143 of the service system 140. For example, the data collection module 114 may rely on an outbound file transfer protocol, such as Hypertext Transfer Protocol Secure (HTTPS), to upload the collected data to the data collector 143 via the network 105. In certain example embodiments, the data collection module 114 may batch process the data upload to the data collection module, such as in size-managed batches. Additionally or alternatively, the data collection module 114 may upload the collected data when the client side user device 110 and associated user network devices 111 are not being otherwise used, such as overnight.

In block 235, based on received data, the service system 140 determines a response to the service request of the user 101. That is, the service system 140 analyzes the received data and—based on the content of the data and the content of the request—generates a response to the request. For example, once the data collector 143 receives the collected data, the data collector 143 communicates the collected data to one or more service analytics applications 144. The service analytics applications 144 then analyze the data, such as by applying a combination of profiling, enriching, analytics, and other modes of processing to the data. The one or more service analytics applications 144 then generate a service product based on the collected data.

The service product can be any type of generated product that is responsive to the service request. For example, the service product may include charts, organized data, results, summaries, reports, documents, spreadsheets, and/or charts related to the service request. In certain example embodiments, the service product may include responsive software. For example, if the service request relates to a need for technical assistance—and the collected data indicates that a software patch is needed—the service product may include a software patch for the user device 110 and/or one or more of the associated user network devices 111.

In block 240, the service system 140 communicates the response to the user device 110 (and hence to the user 101). That is, the service system 140 transmits the responsive service product to the user device 110 of the user 101 via the network 105. For example, the service system 140 may transmit the service product to the user via email and/or text. In certain example embodiments, the user 101 may be notified, such as via an email and/or text, that the processed data is available as a viewable and/or downloadable service product. The user 101 can then receive the service product, for example, by accessing the user record 145 via the web browser 113 and the service portal 141. For example, the user 101 may provide the user's login credentials, such as the user's username and password, to access the user record 145. Upon accessing the user record 145, the user may be able to view and/or download the service product to the user device 110.

### Other Example Embodiments

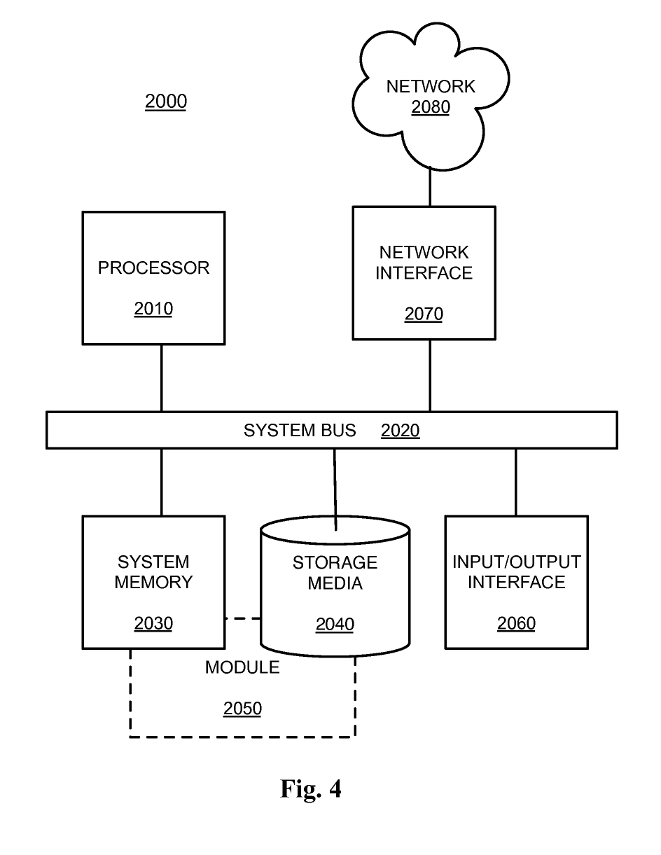

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, instruments, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, instruments, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about subjects, or may make use of personal information, the subjects may be provided with an opportunity or option to control whether programs or features collect subject information (e.g., information about a subject's social network, social actions or activities, profession, a subject's preferences, or a subject's current location), or to control whether and/or how to receive content from the content server that may be more relevant to the subject. In addition, certain data may be treated in one or more ways before it is stored or used, so that personally identifiable information is removed. For example, a subject's identity may be treated so that no personally identifiable information can be determined for the subject, or a subject's geographic location may be generalized where location information is obtained (such as to a city, ZIP code, or state level), so that a particular location of a subject cannot be determined. Thus, the subject may have control over how information is collected about the subject and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. The media may be located in proximity to system 2000, in the Fog layer, or in the Cloud. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the examples described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A method, comprising:
providing, by one or more computing devices, a data collection module to another computing device, in response to a request for a service from the other computing device;
communicating, by the one or more computing devices and to the data collection module provided to the other computing device, a data collection instruction that is selected based on a content of the service request;
receiving, by the one or more computing devices and from the other computing device executing the data collection module, data responsive to the data collection instruction; and
communicating, by the one or more computing devices and to the other computing device, a response to the service request, the response based on the received data.

2. The method of claim 1, wherein the communications from the one or more computing devices occur through a service portal of the one or more computing devices.

3. The method of claim 1, wherein the content of the service request comprises a request for technical assistance.

4. The method of claim 3, wherein the service request comprises an automatic notification of an exception condition.

5. The method of claim 4, wherein the data collection instruction that is selected based on the content of the service request comprises a set of collection instructions formulated for the exception condition.

6. The method of claim 3, wherein the response to the service request comprises a software patch.

7. The method of claim 1, wherein communicating the data collection module to the other computer device comprises:
associating, by the one or more computing systems, a Uniform Resource Locator (URL) with the data collection module; and,
communicating, by the one or more computing systems, the URL associated with the data collection module to the other computer device.

8. The method of claim 7, further comprising detecting access of the URL by the other computing device.

9. The method of claim 8, further comprising confirming, by the one or more computing devices, a connection with the data collection module.

10. The method of claim 1, wherein the data collection instruction comprises a computer program command.

11. The method of claim 10, wherein execution of the command results in the collection of the data associated with the content of the service request.

12. A tangible, non transitory, computer readable media having software encoded thereon, the software when executed by a processor operable to:
communicate, by a user computing device, a service request to a service provider computing system, wherein the user computing device is separate from the service provider computing system;
receive, in response to communicating the request for service to the service provider computing system and from the service provider computing system, a data collection module;
install the data collection module on the user computing device;
receive a data collection instruction from the service provider computing system;
execute, by the data collection module, the received data collection instruction, wherein execution of the data collection instruction results in a collection of data;
communicate the collected data to the service provider computing system; and
receive, in response to communicating the collected data to the service provider computing system, a service product, wherein the service product comprises a content that is responsive to the service request and the collected data.

13. The media of claim 12, wherein communications to the service provider computing system occur through a service portal of the service provider computing system.

14. The media of claim 12, wherein the content of the service request comprises a request for technical assistance and the response comprises a software patch.

15. The media of claim 12, wherein the service request comprises an automatic notification of an exception condition.

16. The media of claim 15, wherein the data collection instruction that is received from the service provider computing system comprises a set of collection instructions formulated for the exception condition.

17. The media of claim 12, wherein the data collection instruction comprises a computer program command, the execution of the command resulting in the collection of the data associated with the content of the service request.

18. An apparatus, comprising:
a processor adapted to execute one or more processes; and
a memory configured to store a process executable by the processor, the process when executed operable to:
receive a request for a service, wherein the service request is received from a user computing device;
communicate, in response to receiving the service request, a data collection module to the user computer device;
determine a content of the service request;
determine a data collection instruction based on the content of the service request;
communicate, to the data collection module, the data collection instruction;
receive, in response to communicating the data collection instruction to the data collection module and from the user computing device executing the data collection instruction via the data collection module, data associated with the content of the service request;
determine, in response to receiving the data, a response to the service request; and
communicate the response to the user computing device.

19. The apparatus of claim 18, wherein the communications occur through a service portal.

20. The apparatus of claim 18, wherein the content of the service request comprises a request for technical assistance and the response comprises a software patch.

21. The apparatus of claim 18, wherein the request comprises an automatic notification of an exception condition, and wherein the data collection instruction that is selected based on the content of the service request comprises a set of collection instructions formulated for the exception condition.

22. The apparatus of claim 18, where the data collection instruction comprises a computer program command, the execution of the command resulting in the collection of the data associated with the content of the service request.
